(19) United States
(12) Patent Application Publication
(10) Pub. No.: US 2013/0226694 A1
(43) Pub. Date: Aug. 29, 2013

(54) ADVERTISER GIFT CARD OFFER FOR FREE VIRTUAL CURRENCY OR DIGITAL PRODUCT OF ONLINE PUBLISHER AT ELECTRONIC PAYMENT PLATFORM

(71) Applicants: Kai BOYD, Munchen (DE); Thomas Porzner, Munchen (DE); Jarg Temme, Munchen (DE)

(72) Inventors: Kai BOYD, Munchen (DE); Thomas Porzner, Munchen (DE); Jarg Temme, Munchen (DE)

(73) Assignee: Deal United GmbH, Munchen (DE)

(21) Appl. No.: 13/407,784

(22) Filed: Feb. 29, 2012

(51) Int. Cl. G06Q 30/02

(52) U.S. Cl. 705/14.49

(57) ABSTRACT

An electronic commerce transaction in which a dealer electronically purchases gift cards of different face amounts from different advertisers using a computer online, each gift card is purchased for a fixed sum equal to a face amount less a discount. The dealer may electronically pay for virtual currency from an online publisher of an online game at a second discount for a second fixed sum in real currency units, the first discount minus the second fixed sum representing the dealer's margin, the virtual currency usable in the online game. The dealer electronically offers to online game users the gift cards stating that if a user purchases electronically from the dealer one of the gift cards the user is then entitled to a preset amount of the virtual currency for the online game. The dealer may offer a similar offer where the free item is an online publisher's product.

### FIELD AND BACKGROUND OF THE INVENTION

The present invention relates to apparatuses and methods for electronic commerce, and more particularly for offering gift cards on an electronic payment platform in exchange for free virtual currency in online games or free products from online publishers.

Merchants and advertisers are always looking for new ways to increase revenues. In addition, for online publishers and online advertisers, it is particularly important for such ways to be efficient. Consumers are looking for new ways to purchase goods and services.

Online game publishers are known to offer special items and virtual currencies to users of the online game. The areas where game publishers offer these “actions” are called “Cash for Action”, “Earn credits/coins” or “Offerwalls”. Although these actions may stimulate some further use of the online games, they do not necessarily stimulate users of the online games who would not purchase virtual currency to do so.

There is a compelling need to have systems and methods that will allow online publishers of online games to sell virtual currency to consumers who might otherwise not be willing to purchase such virtual currency, and to allow online publishers of products to sell these products to consumers who might otherwise not be willing to pay for such digital goods. It would be particularly helpful to achieve this while also efficiently increasing revenues of other vendors and retailers of goods and services while creating new and appealing ways for consumers to benefit.

### SUMMARY OF THE PRESENT INVENTION

One aspect of the present invention is a method of performing an electronic commerce transaction, comprising the dealer electronically purchasing gift cards of at least two different face amounts from at least two advertisers using a computer online, each gift card is purchased for a fixed sum equal to a face amount of the gift card less a first discount in real currency units, said each gift card entitling a holder thereof to redeem the gift card towards an electronic purchase of a product of the advertiser who issued the gift card; the dealer using a computer online to electronically purchase virtual currency from an online publisher of an online game for a second fixed sum at a second discount in real currency units, the first discount greater than the second fixed sum, the virtual currency usable in the online game; and using a computer online, the dealer makes an offer on a dealer payment platform to users of the online game to sell gift cards of the at least two different face amounts of the at least two advertisers, the offer stating that if a user purchases electronically one of the gift cards of the at least two different face amount of the at least two advertisers from the dealer the user is then entitled to a preset amount of the virtual currency of the online game for free.

A further aspect of the present invention is a method of performing an electronic commerce transaction, comprising the dealer electronically purchasing gift cards of at least two different face amounts from at least two advertisers using a computer online, each gift card is purchased for a fixed sum equal to a face amount of the gift card less a first discount in real currency units, the gift card entitling a holder thereof to redeem the gift card towards an electronic purchase of products of the advertiser who issued the gift card; the dealer using a computer online to electronically purchase a digital product from an online publisher for a second fixed sum at a second discount in real currency units, the first discount minus the second fixed sum representing a first margin for the dealer; and using a computer online, the dealer making an offer on a dealer payment platform to users to sell the gift cards of the at least two different face amounts of the at least two advertisers, the offer stating that if a user purchases electronically from the dealer one of the gift cards, the user is then entitled to a particular digital product of the online publisher for free.

These and other features, aspects and advantages of the present invention will become better understood with reference to the following drawings, descriptions and claims.

### BRIEF DESCRIPTION OF THE DRAWINGS

Various embodiments are herein described, by way of example only, with reference to the accompanying drawings, wherein:

FIG. 1 is a schematic flow chart showing a method involving an online game publisher, in accordance with one embodiment of the present invention;

FIG. 2 is a more detailed schematic flow chart for the method of FIG. 1, in accordance with one embodiment of the present invention;

FIG. 3 is a schematic flow chart showing a method involving an online publisher of digital goods, in accordance with one embodiment of the present invention;

FIG. 4 is a flow chart showing the payment workflow for the delivery of digital products and gift cards, in accordance with one embodiment of the present invention;

FIG. 5 is a flow chart showing a method in accordance with one embodiment of the present invention; and

FIG. 6 is a flow chart showing a further method in accordance with one embodiment of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

The present invention generally provides a method of performing an electronic commerce transaction in which a dealer electronically purchases gift cards of different face amounts from different advertisers using a computer online, each gift card is purchased for a fixed sum equal to a face amount of the gift card less a first discount in real currency units, which discount may vary with the advertiser. The gift card entitles a holder thereof to redeem the gift card towards electronic purchase of a product or service of the advertiser who issued the gift card. The dealer using a computer online may electronically pay for virtual currency from an online publisher of an online game at a second discount for a second fixed sum in real currency units, the second fixed sum less than the first discount by an amount representing a first margin for the dealer, the virtual currency usable in an online game of the online publisher. The dealer may electronically offer to users of the online game the gift cards stating that if a user purchases electronically from the dealer one of the gift cards the user is then entitled to a preset amount of the virtual currency for the online game.

In contrast to prior art electronic payment platforms in which payment for virtual currency of an online game of an online publisher is exchange for real currency, the electronic payment platform of the present invention enables a user of the online game to buy a gift card of an advertiser unrelated to the online publisher to obtain the virtual currency of the online publisher. In contrast to prior art electronic commerce transactions in which fulfillment of an offer of an advertiser entitles a user to receive an online publisher's offer at new terms, in the electronic payment platform of the present invention a gift card of the advertiser is not offered by the advertiser; rather it is offered by a dealer who purchases and sells the gift cards. In further contrast to the prior art, the user deals only with the dealer and that dealer offers a separate payment platform. In further contrast to prior art electronic commerce transactions in which fulfillment of an advertiser's offer entitles a user to receive an online publishers' offer at new terms, in the present invention the user who buys the gift card from the dealer need not redeem the gift card with the advertiser at all in order to obtain the product or virtual currency of the online publisher. The user in fact may have no dealings with the advertiser either at the time of the offer or thereafter. In still further contrast to such electronic commerce transactions, if the user of the online game purchases the gift card the user may obtain an amount of virtual currency at a preset exchange rate which may vary with the online publisher. In further contrast to such electronic commerce transactions, when the user buys the gift card, the user obtains the virtual currency or online publisher product for free. In still further contrast to electronic commerce transactions, the electronic commerce transaction of the present invention may involve the dealer electronically purchasing gift cards of at least two different face amounts from at least two advertisers using a computer online. In still further contrast to the prior art, each gift card may be purchased for a fixed sum equal to a face amount of the gift card less a first discount in real currency units. In contrast to the prior art, the gift card may be transferable. In further contrast to the prior art, in the present invention the dealer may purchase virtual currency from an online publisher of an online game at a discounted amount thereby allowing the dealer to offer the free virtual currency to the user on condition that the user buy the gift card from the dealer. Furthermore, the dealer's purchase of the virtual currency is at an absolute amount in real currency units less than the absolute amount of the discount by the advertiser for the dealer's purchase of the gift card, the difference representing a first margin for the dealer, which may be a profit margin. In contrast to prior art methods of increasing revenues, the present invention may increase revenues for the online publishers and the advertisers and create revenues for the dealer. It may increase revenues for the online publisher by providing an additional marketing tool to sell virtual currency or digital products to users who may be unwilling to pay the regular price directly without getting that special offer. The online publisher instead charges a discounted amount to the dealer who offers the virtual currency for free to users to whom the dealer also resells the gift card. It may also generate increased revenues and attract new customers for the advertiser who is able to sell gift cards at a discount to dealers who resell them to users for the face amount who may not have been willing to pay the full price for the gift card by buying it directly from the advertiser without the special incentive of obtaining the virtual currency or the free digital product for free. The dealer creates revenues for itself by setting up the whole system and identifying a profit margin representing the difference between the second fixed sum (charged by the online publisher) and the first discount offered by the advertiser.

The principles and operation of a method and apparatus for an advertiser gift card offer for free virtual currency or product of online publisher in electronic payment platform may be better understood with reference to the drawings and the accompanying description.

The term “computer” as used herein relating to the present invention refers to computer hardware but also includes mobile telephone devices that have computer processors and other electronic devices capable of accessing the World Wide Web and making electronic purchases of digital goods. The terms “digital products” and “digital goods” are used interchangeably and include services that are stored, used and to delivered electronically (i.e. digital services). Non-limiting examples of digital goods are software; downloadable products such as music and videos; and virtual goods. One example of a digital service is a membership status. The term “online publisher” means an online merchant. The term “dealer” refers to the entity that sponsors and/or operates the system or method of the present invention. The dealer's shopping platform or shopping model is sometimes called “Pay by Shopping. The term “advertiser” or “online advertiser” refers to an online shopping partner who is a retailer of goods (not necessarily digital goods) via an online shop and who also sells gift cards relating to its products and goods via a large electronically-accessible telecommunications network, such as the World Wide Web. The term “face amount” is the stated value of the gift card that appears on the gift card. For example a gift card having a $50 face amount may entitle the user to purchase digital goods from the advertiser issuing the gift card in an amount of $50 (or more than $50 in some preferred embodiments).

The terms “first discount”, “second discount” and “third discount” refer to discounts of absolute amounts rather than discounts measured as a percentage of a price.

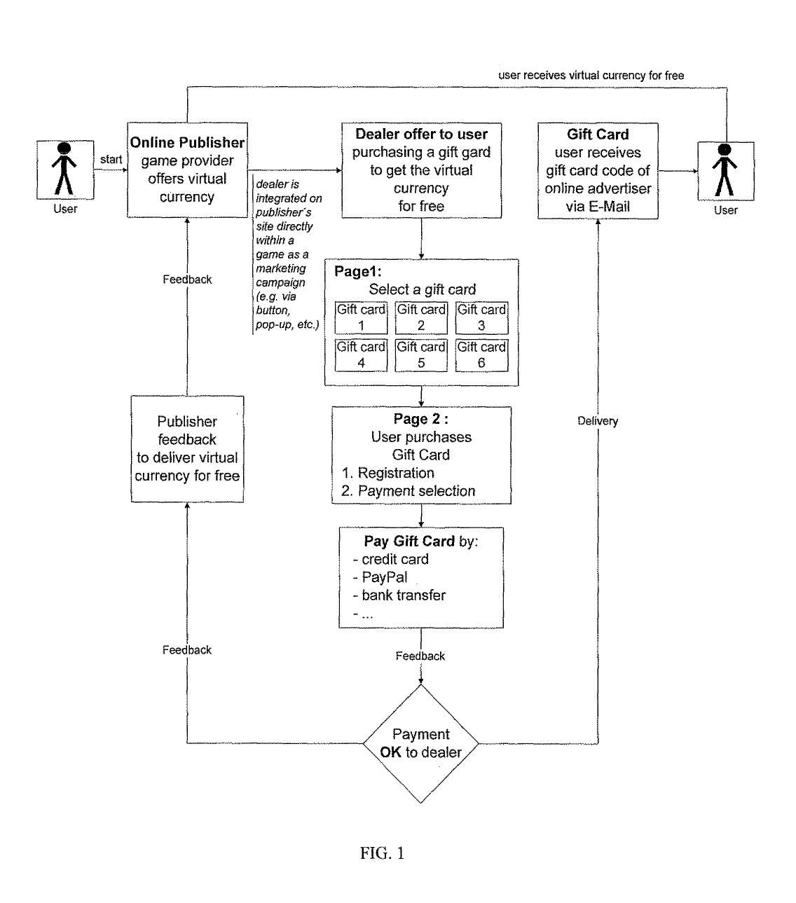

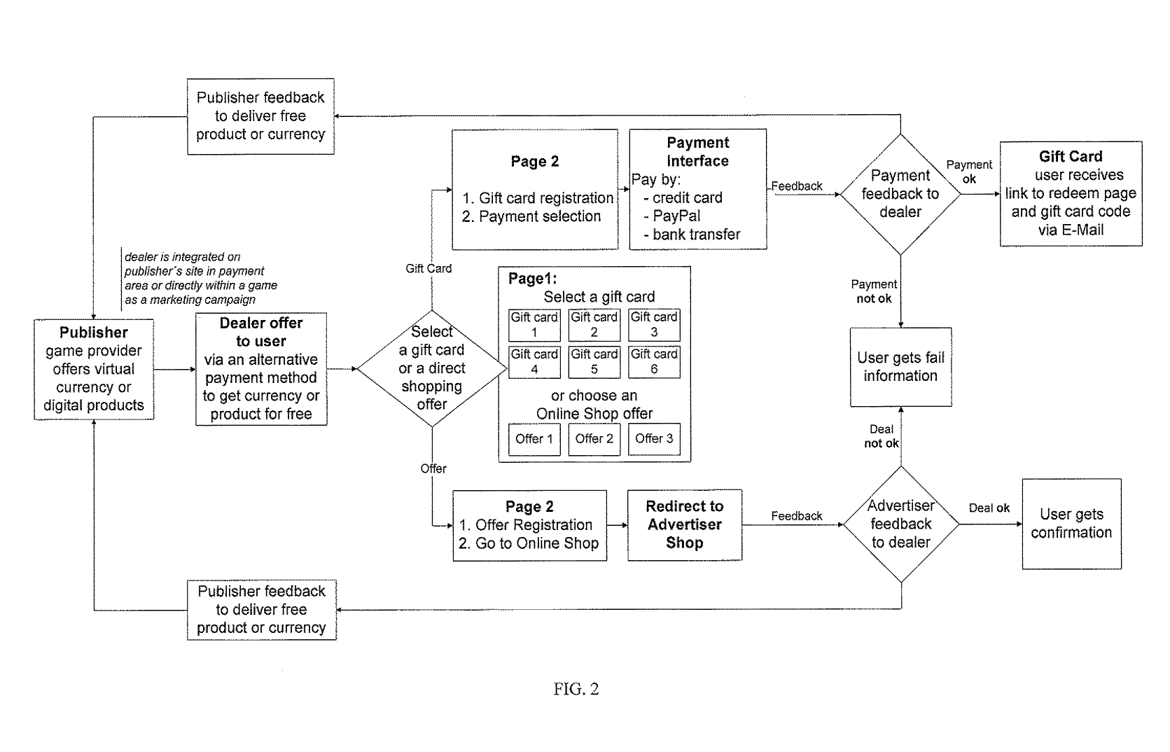

As seen from FIGS. 1, 2, 4, a first method of performing an electronic commerce transaction is presented. A dealer (which may be a company) may electronically purchase gift cards of at least two different face amounts from at least two advertisers, and preferably at least two different face amounts from each of the at least two advertisers, using a computer online. The advertisers may be online advertisers. Preferably, the dealer purchases gift cards online from at least three or at least four or at least five or at least ten advertisers. For example, Company X gift cards may be available in denominations of 20 Dollars (US), 25 Dollars (US), 50 Dollars (US), 100 Dollars (US) or any other numerical amount and in any currency, preferably real currency. Gift cards issued by a particular advertiser may entitle a holder of the gift card to redeem the gift card for a specified amount of digital goods or services of the advertiser that issued the gift card. The specified amount is called the “face amount” of the gift card. The gift card, in some preferred embodiments, may contain limitations, such as geographic limitations and time limitations in which to redeem the gift card. In some more unusual embodiments, the gift card may contain other limitations such as limitations as to the nature of the goods and services that can be obtaining using the gift card. In some cases, the face amount can be usable toward a specific product and the user will only get the mentioned product when redeeming the gift card at the advertiser shop.

Each gift card may be purchased for a fixed sum in real currency units equal to a face amount of the gift card less a first discount to the dealer. For example, a 50 Dollar (US) gift card may be offered to the dealer by Company X at 35 Dollars (US). That leaves 15 Dollars (US) for the dealer to split with the online publisher. The 15 Dollars (US) in this example represents the first “absolute amount” discount, meaning the discount in absolute terms (not percentage) on the first side of the arrangement, which is called the first discount. The first side of the arrangement is with the advertiser.

The dealer may also purchase gift cards from a different advertiser under different terms. For example Company Y may offer a 100 Dollar (US) gift card for 80 Dollars (US) to the dealer. That would leave 20 Dollars (US) initial profit for the dealer to share with the online publisher. One particular advertiser may have more appeal to men as opposed to women, for example Company X, and a different advertiser may appeal more to women, for example Company Y. Furthermore, one advertiser may offer their gift cards with the stipulation that can be redeemed in one particular country (e.g. U.K.) whereas a different advertiser may stipulate that its gift cards are redeemable in a different particular country or geographical region (e.g. Germany).

Each gift card purchased by the dealer may entitle a holder thereof to redeem the purchased gift card towards an electronic purchase of a product of the advertiser who issued the gift card. The term “product” is not intended to exclude a “service”. Each gift card may also entitle the holder to transfer the purchased gift card to someone else for redemption by that someone else towards purchase of a product of that advertiser. In this patent application “electronically purchase” means purchasing online using a computer where “online” means operatively connected to a telecommunications network such as the Internet. In other embodiments, “online” means operatively connected to a telecommunications network that is the Internet. Using a telephone or other device to make an online purchase in a manner that utilizes a computer processor is also considered “using a computer”. In some exceptional versions, the gift card may be redeemed physically at a store.

In addition to dealing with online advertisers, the dealer may use a computer online to electronically purchase virtual currency from an online publisher of an online game. The virtual currency may be usable in the online game. When referring in this patent application to the dealer using a computer online to “electronically purchase” virtual currency from an online publisher (or in the case of the second method to “electronically purchase” a product from an online publisher), the “purchase” does not involve actually taking possession of what is purchased, i.e. the virtual currency. The “electronic purchase” is in effect divided between the dealer who satisfies the payment obligations toward the online publisher, and the user who takes “possession” of that which is purchased, at least virtual possession in the case of the user's taking the virtual currency for use in the online game. This division also holds true for the “electronic purchase” of products in regard to the second method. The relative timing of these two portions of the “purchase” may vary but in some preferred embodiments the dealer does not necessarily pay the online publisher prior to the user being allowed to “take possession” of the virtual currency (or digital product). Rather, the dealer merely notifies the online publisher that the online publisher should allow the user to take or use the virtual currency or digital product since the dealer has been notified that the user purchased the gift card having the appropriate denomination (face amount). The dealer may satisfy the payment obligation for the electronic purchase by making regular payments to the online publisher, for example monthly, and may include the discounted payment for the virtual currency or digital product in one of the monthly payments following the transaction in which the user took possession or used that virtual currency or digital product. In other preferred embodiments, the dealer may pay the online publisher prior to the user being allowed to “take possession” or make use of the virtual currency. Accordingly, the electronic purchase by the dealer referred to in this patent application may encompass merely satisfying the payment obligation for the virtual currency (or digital product). This applies to both the first and second methods described herein.

The dealer may electronically “purchase” the virtual currency from several different online publishers of online games, for example at least two online publishers or at least three, or at least four or at least five or at least ten. When the dealer purchases the virtual currency it may be at a second fixed sum at a discount measured in a second absolute amount in real currency units. This second fixed sum may be less than the first discount and the difference may be an amount representing a first margin for the dealer, which may be a profit margin. For example, in the above example with Company X gift cards, the dealer may purchase eighty virtual currency coins normally costing 10 Dollar (US) for 6 Dollars (US). The six Dollars (US) is the second fixed sum and is less than the 15 Dollar (US) of the first discount. Since the dealer has paid Company X, the advertiser, 35 Dollars (US) for the 50 Dollar (US) gift card, and has paid the online publisher 6 Dollars (US), the dealer has a profit margin (which may be called the first margin since it is with a first online publisher) of 9 Dollars (US) in this example since the dealer may sell to a user of the online game of the online publisher this gift card carrying a face value of 50 Dollars (US) for 50 Dollars (US) (and the expenses of the dealer total 41 Dollars (US)).

In the second example, where the dealer paid 80 Dollars (US) to Company Y to buy a Company Y gift card having a face value of 100 Dollars (US), the first discount would be 20 Dollars (US). If the online publisher sells virtual currency that normally costs 100 coins (of virtual currency) for 20 Dollars (US) to the dealer for 15 Dollars (US), the dealer has a second discount of 5 Dollars (US). The second fixed sum is 15 Dollar (US) which is less than the first discount by 5 Dollars (US) for a profit margin (‘first margin”) of 5 Dollars (US), in this example.

The dealer may purchase virtual currency from many different online publishers (for example at least one, at least two, at least three, at least four, at least five, at least ten, etc.) and each online publisher may agree to a different exchange rate between the virtual currency used in that online publisher's online game and the second fixed sum in real currency paid by the dealer to the online publisher. That is, the relative discount for the virtual currency offered to the dealer may vary from one online publisher to another.

Now that the dealer has dealt with online advertisers and with at least one online publisher, using a computer online, the dealer may make an offer, for example on a dealer payment platform, to users of the online game for sale of the gift cards of the at least two different face amount of the at least two advertisers. The offer may state that if a user purchases electronically from the dealer one of the gift cards of the at least two different face amount of the at least two advertisers the user is then entitled to a preset amount of the virtual currency of the online game for free. For example, if the user purchases a 100 Dollar (US) gift card online, the user additionally gets 100 coins of virtual currency usable in the online game of the online publisher.

The dealer's offer may be integrated into the online game of the online publisher in at least two different ways. In the first way, during the check-out process, where users of the online game normally decide to purchase virtual currency or virtual items for the online game, the user is offered, along with an option to pay by credit card or PayPal, the option to obtain the virtual currency using the “Pay by Shopping platform”. If the user selects that option the user may be taken to a separate page or platform provided by the dealer (i.e. obtain the virtual currency for free upon purchase of various advertising partner's gift cards that are shown in various denominations). In a second way that the dealer's offer may be integrated into the online game directly, the dealer's offer may appear in a separate pop-up, a separate landingpage, a pop under, a layer, a banner to be shown on the game surface directly, within in-game messages, in the news or in a forum of the online game, or even in a promotional email sent by the online game publisher. This offer may appear on a screen of the user during the user's participation in the online game.

When the user uses a computer to pay the dealer online the face amount of the gift card that the user purchased this may trigger an indication of the user's payment which may automatically generate an electronic transmission of a code sent from the dealer to the user. This gift card code may in effect represent the gift card since no actual gift card, virtual or physical, is generated other than the code. In addition, the user's payment may also automatically generate an electronic transmission from the dealer to the online publisher indicating to the online publisher that the user is entitled to the preset amount of the virtual currency. This authorizes and permits the user to immediately use the virtual currency in the online game of the online publisher.

It is noted that the dealer may never identify to the online publisher the at least two advertisers nor the online publisher to the at least two advertisers.

In dealing with the online publisher, the amount of the virtual currency for the online game provided to the user during the online game in exchange for a particular face amount of a gift card of a particular advertiser may be set based on an availability of a profit margin for the dealer after subtracting the second fixed sum charged by the online publisher to the dealer for the virtual currency from the first discount provided by the advertiser to the dealer. The dealer, knowing the second fixed sum that it paid or will pay for the virtual currency, may identify (and purchase a gift card from) an advertiser willing to sell the gift card at a first discount off the face amount of the gift card such that the first discount exceeds the second fixed sum, and exceeds that second fixed sum by an amount that the dealer feels is comfortable as a profit margin.

A further aspect of the first method is that the amount of the first discount may vary from one advertiser to another. Accordingly, the amount of virtual currency a user will get for a purchasing a gift card having a given face amount may vary because it is based on the amount of the first discount of the advertiser that sold the gift card to the dealer.

The dealer may purchase virtual currency from more than one online publisher of online games. For example, the dealer may use a computer online to electronically purchase virtual currency from a second online publisher of an online game at a third absolute amount discount for a third fixed sum in real currency units, the third fixed sum less than the first discount by an amount representing a second margin for the dealer, the virtual currency usable in the online game of the second online publisher. Note that the third fixed sum is to the second online publisher what the second fixed sum is to the first online publisher since the first fixed sum relates to the advertiser.

After purchasing virtual currency from the second online publisher, the dealer, using a computer online, may make an offer, for example on a dealer payment platform, to users of the online game of the second online publisher for sale of gift cards of at least two different face amounts of at least two advertisers, the offer stating that if a user purchases electronically from the dealer one of the gift cards of the at least two different face amounts of the at least two advertisers offered to users of the online game of the second online publisher, the user is then entitled to a preset amount of the virtual currency for the online game of the second online publisher. The gift cards offered to users of the online games operated by the first online publisher may be the same or may be different from the gift cards offered to users of the online games of the second online publisher.

It is noted that the holder of the gift card need not ever redeem the gift card or ever transfer the gift card to a new holder in order to obtain the preset amount of the virtual currency for the online game.

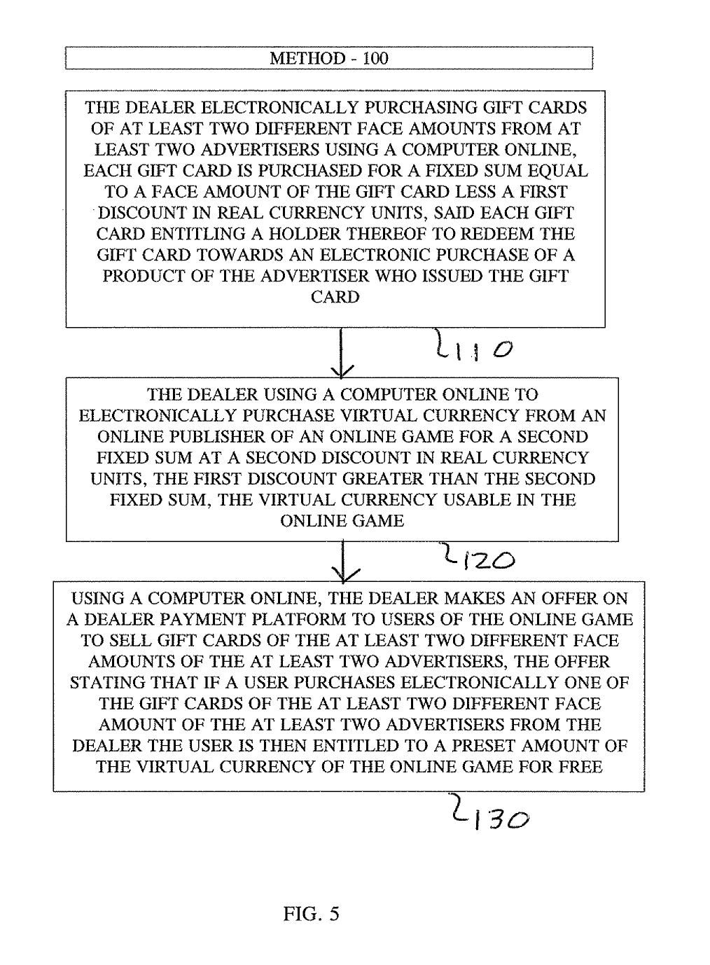

As seen from FIG. 5, method 100 of performing an electronic commerce transaction, may have a step 110 of the dealer, using a computer online, electronically purchasing gift cards of at least two different face amounts from at least two advertisers, each gift card purchased for a fixed sum equal to a face amount of the gift card less a first discount in real currency units, said each gift card entitling a holder thereof to redeem the gift card towards an electronic purchase of a product of the advertiser who issued the gift card. In preferred embodiments, each gift card also entitles the holder to transfer the said each gift card to someone else for redemption by that other person towards purchase of a product of the advertiser who issued the gift card.

Method 100 may have a further step 120 of the dealer using a computer online to electronically purchase virtual currency from an online publisher of an online game for a second fixed sum at a second discount in real currency units, the first discount greater than the second fixed sum, the virtual currency usable in the online game.

Method 100 may also have a step 130 of the dealer, using a computer online, making an offer on a dealer payment platform to users of the online game to sell gift cards of the at least two different face amounts of the at least two advertisers, the offer stating that if a user purchases electronically one of the gift cards of the at least two different face amount of the at least two advertisers from the dealer, the user is then entitled to a preset amount of the virtual currency of the online game for free.

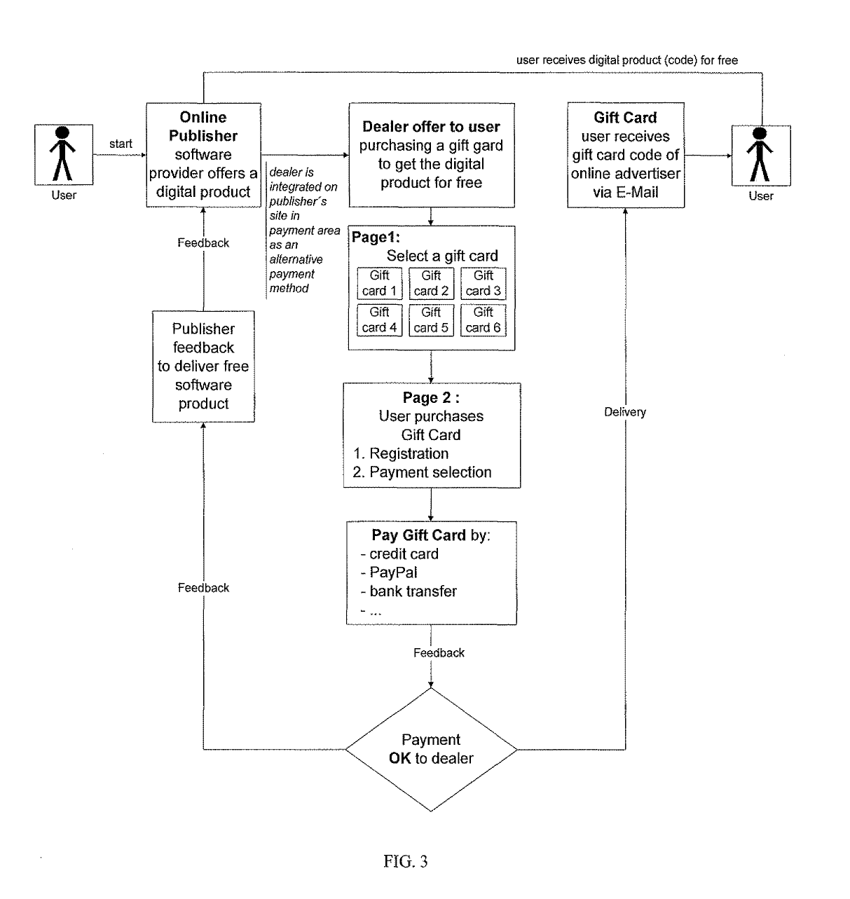

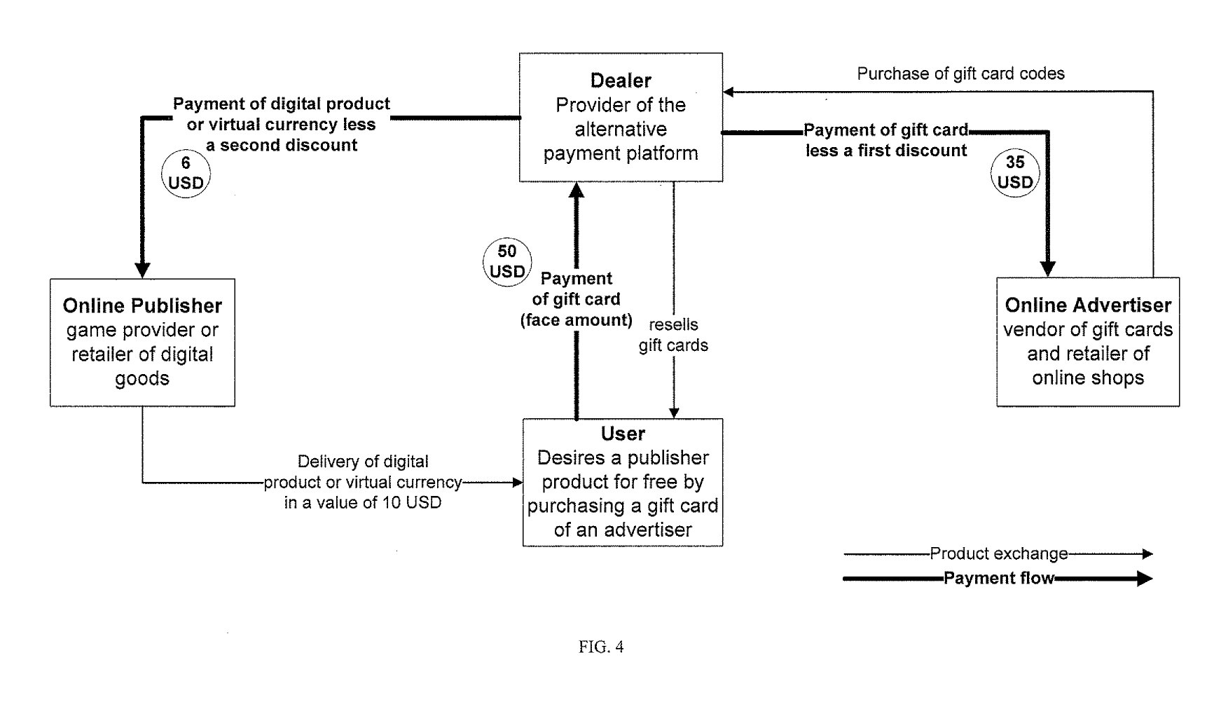

As seen from FIGS. 3-4, the present invention may also be a second method of performing an electronic commerce transaction. In this second method, the transaction involves products rather than online games. There are some differences between the first and second methods since virtual currency is not involved and instead a product is involved but the basic idea is the same. In this second method involving products, the dealer may electronically purchase gift cards of at least two different face amounts from at least two advertisers, and preferably at least two different face amounts from each of the at least two advertisers, using a computer online.

The advertisers may be online advertisers. As with the first method, with the second method each gift card may be purchased for a fixed sum equal to a face amount of the gift card less a first discount in real currency units. In this case, though, the gift card entitles a holder thereof to redeem the gift card towards an electronic purchase of a product of one of the advertisers. It may also entitle the holder to transfer the gift card to someone else for redemption by that someone else towards purchase of a product of the advertiser that issued the gift card. As with the first method, the term “product” is not intended to exclude a “service”.

In addition to purchasing gift cards from online advertisers, the dealer may use a computer online to electronically purchase a product from an online publisher at a second discount for the dealer in exchange for a second fixed sum in real currency units. The second fixed sum may be less than the first discount by an amount representing a first margin for the dealer.

Using a computer online, the dealer may make an offer, for example on a dealer payment platform, to users for sale of the gift cards. A dealer payment platform can be a page of the online publisher's site or the dealer's own site or any other online site that a user is directed to when trying to pay for a product of an online publisher. The gift cards that are offered would normally be of the at least two different face amounts of the at least two advertisers. The gift cards that are offered could also be one gift card of one advertiser, or they can be two gift cards of the same face amount but from two different advertisers, or two or more gift cards of different face amounts each from different advertisers, or one gift from one advertiser and two or more gift cards from a second advertiser with one or more of the gift cards carrying different face amounts, or any another permutation. In addition, the offer could be for at least three or at least five or at least ten different gift cards from at least three or at least five or at least ten different advertisers. The offer may state that if the user purchases electronically from the dealer one of the gift cards the user is then entitled to a particular product of the online publisher.

For example, a digital product such as a game item or software sold by an online publisher is normally offered at 20 Dollars (US). Instead, the online publisher offers the software to the dealer at a “second fixed sum” (so named because the first fixed sum is the fixed sum paid by the dealer for the gift card) for 10 Dollars (US). The dealer may then approach online advertisers who sell gift cards at a discount (a “first discount”) greater than the second fixed sum. The dealer in this example may seek gift cards at a discount equal to at least 18 Dollars (US), to support a profit margin of at least 8 Dollars (US). For gift cards having a face amount of 100 Dollars (US), this means the dealer may be willing to pay up to 82 Dollars (US) for the gift card. This way, the dealer pays a first fixed sum for the gift card (10 Dollars (US)) and a second fixed sum for the gift card (up to 82 Dollars (US)) and the sum of these two sums is still less than the face amount of the gift card (100 Dollars (US)) by a profit margin of at least 8 Dollars (US) in this example. The dealer can then offer user that they can obtain the software (normally worth 20 Dollars (US)) for free if they purchase the 100 Dollar (US) gift card. The dealer may interact with the user when the user reaches a payment platform of the online publisher.

In some preferred embodiments, the other features of this second method involving products are similar to the features of the first method involving virtual currency. For example, a further aspect of the second method may be that the amount of the first discount may vary from one advertiser to another. Accordingly, the values of the digital goods that a user will get for purchasing a gift card of a given face amount may vary because it is based on the amount of the first discount of the advertiser that sold the gift card to the dealer. In a further example, when the user uses a computer to pay the dealer online the face amount of the gift card that the user purchased, an indication of the user's payment may automatically generate from the dealer an electronic transmission of a code to the user, the code representing the gift card. This code may in effect represent the gift card since no physical gift card, is normally handed out. The code may be sent out via e-mail but in some embodiments the code may be generated in a printable or personalized way. In addition, the user's payment may also automatically generate an electronic transmission from the dealer to the online publisher indicating to the online publisher that the user is entitled to the product of the online publisher. In some other embodiments, the dealer may also communicate to the user that the user's payment has been successfully completed and may issue a code to the user that the user can use to directly download digital goods (e.g. software) directly from the dealer.

It is not necessary for the dealer to identify to the online publisher the identity of the at least two advertisers or to identify the online publisher to the advertisers. The advertisers and online publishers may be uninvolved with one another since the online publisher need not see or know the details of the gift cards. In certain preferred embodiments, however, the dealer allows the online publisher to have a veto right over certain types of advertisers, for example those dealing with adult material.

The dealer may electronically “purchase” products from more than one online publisher. For example, the dealer using a computer online may also electronically purchase a product from a second online publisher for a third fixed sum at a third absolute amount discount in real currency units. The third fixed sum may be less than the first discount by an amount representing a second margin for the dealer (called “second margin” since it relates to the second online publisher that the dealer deals with). The product may be offered online by the second online publisher.

Using a computer online, the dealer may make an offer, for example on a dealer payment platform, to users who buy or are considering buying products of the second online publisher or who may be at an electronic site of the second online publisher. The dealer's offer may be for sale of gift cards of at least two different face amounts of at least two advertisers. The offer may state that if a user purchases electronically from the dealer one of the gift cards of the at least two different face amounts of the at least two advertisers, the user is then entitled to a particular product of the second online publisher.

The gift cards offered to users to obtain free products of the first online publisher and the gift cards offered to users to obtain free products of the second online publishers may be the same gift cards or may be different gift cards. The holder of the gift card need not ever redeem the gift card or ever transfer the gift card to a new holder in order to obtain the product of the online publisher.

Particular features described in the context of one embodiment may be able to be incorporated into other embodiments for which that feature was not specifically mentioned.

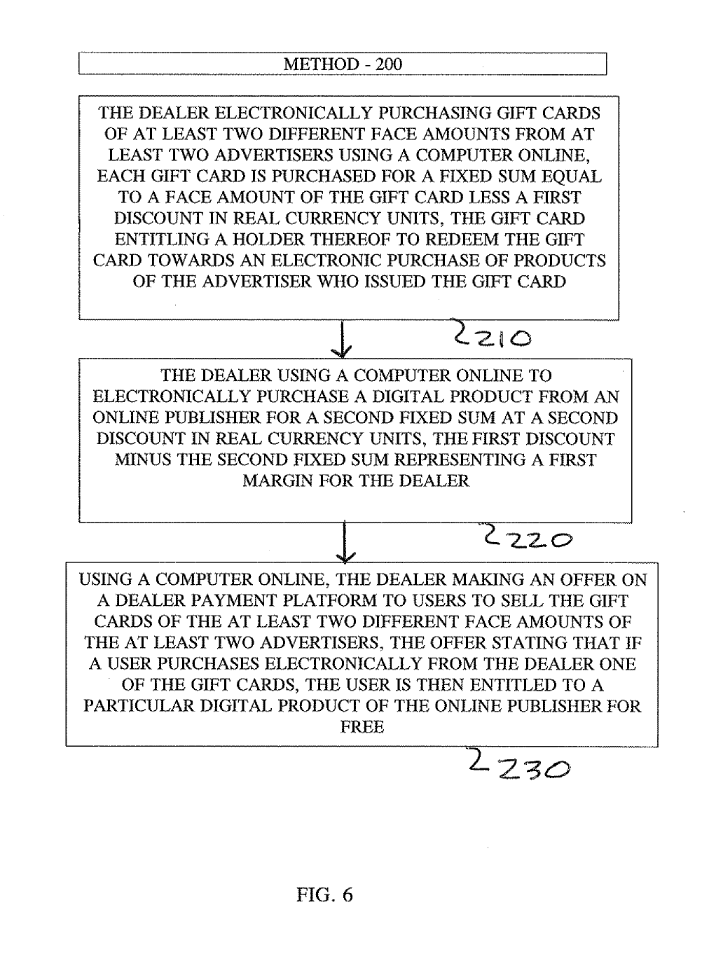

As seen from FIG. 6, method 200 of performing an electronic commerce transaction, may comprise a step 210 of the dealer, using a computer online, electronically purchasing gift cards of at least two different face amounts from at least two advertisers, each gift card purchased for a fixed sum equal to a face amount of the gift card less a first discount in real currency units, the gift card entitling a holder thereof to redeem the gift card towards an electronic purchase of products of the advertiser who issued the gift card. In preferred embodiments, the gift card also entitles the holder to transfer the gift card to someone else for redemption by that someone else towards purchase of a product of the advertiser who issued the gift card.

Method 200 may have a further step 220 of the dealer using a computer online to electronically purchase a digital product from an online publisher for a second fixed sum at a second discount in real currency units, the first discount minus the second fixed sum representing a first margin for the dealer.

Method 200 may also have a step 230 of the dealer, using a computer online, making an offer on a dealer payment platform to users to sell a gift card of the at least two different face amounts of the at least two advertisers, the offer stating that if a user purchases electronically from the dealer one of the gift cards the user is then entitled to a particular digital product of the online publisher for free.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. A method of performing an electronic commerce transaction, comprising:
the dealer electronically purchasing gift cards of at least two different face amounts from at least two advertisers using a computer online, each gift card is purchased for a fixed sum equal to a face amount of the gift card less a first discount in real currency units, said each gift card entitling a holder thereof to redeem the gift card towards an electronic purchase of a product of the advertiser who issued the gift card;
the dealer using a computer online to electronically purchase virtual currency from an online publisher of an online game for a second fixed sum at a second discount in real currency units, the first discount greater than the second fixed sum, the virtual currency usable in the online game; and
using a computer online, the dealer makes an offer on a dealer payment platform to users of the online game to sell gift cards of the at least two different face amounts of the at least two advertisers, the offer stating that if a user purchases electronically one of the gift cards of the at least two different face amount of the at least two advertisers from the dealer the user is then entitled to a preset amount of the virtual currency of the online game for free.

2. The method of claim 1, further comprising the user using a computer to pay the dealer online the face amount of the gift card that the user purchased, indication of the user's payment automatically generating from the dealer an electronic transmission of a code to the user, the code representing the gift card.

3. The method of claim 2, further comprising the user's payment also automatically generating an electronic transmission from the dealer to the online publisher indicating to the online publisher that the user is entitled to the preset amount of the virtual currency for free.

4. The method of claim 1, further comprising the dealer not identifying to the online publisher the at least two advertisers nor the online publisher to the at least two advertisers.

5. The method of claim 1, further comprising the amount of the virtual currency for the online game provided to the user during the online game in exchange for a particular face amount of a gift card of a particular advertiser is set based on an availability of a profit margin for the dealer after subtracting the second fixed sum charged by the online publisher to the dealer for the virtual currency from the first discount provided by the advertiser to the dealer.

6. The method of claim 5, further comprising varying an exchange rate between the virtual currency and the face amount of the gift card based on the amount of the first discount of the advertiser that sold the gift card to the dealer.

7. The method of claim 1, further comprising
the dealer using a computer online to electronically purchase virtual currency from a second online publisher of an online game at a third absolute amount discount for a third fixed sum in real currency units, the third fixed sum less than the first discount by an amount representing a second margin for the dealer, the virtual currency usable in the online game of the second online publisher.

8. The method of claim 7, further comprising
using a computer online, the dealer making an offer on the second online publisher's payment platform to users of the online game of the second online publisher for sale of gift cards of at least two different face amount of at least two advertisers, the offer stating that if a user purchases electronically from the dealer one of the gift cards of the at least two different face amount of the at least two advertisers offered to users of the online game of the second online publisher the user is then entitled to a preset amount of the virtual currency for the online game of the second online publisher.

9. The method of claim 8, further comprising the gift cards offered to users of online games of the first online publisher are the same as the gift cards offered to users of online games of the second online publisher.

10. The method of claim 1, further comprising the holder of the gift card need not ever redeem the gift card or ever transfer the gift card to a new holder in order to obtain the preset amount of the virtual currency for the online game.

11. The method of claim 1, further comprising the dealer electronically purchasing gift cards of at least two different face amounts from each of the at least two advertisers.

12. A method of performing an electronic commerce transaction, comprising:
the dealer electronically purchasing gift cards of at least two different face amounts from at least two advertisers using a computer online, each gift card is purchased for a fixed sum equal to a face amount of the gift card less a first discount in real currency units, the gift card entitling a holder thereof to redeem the gift card towards an electronic purchase of products of the advertiser who issued the gift card;
the dealer using a computer online to electronically purchase a digital product from an online publisher for a second fixed sum at a second discount in real currency units, the first discount minus the second fixed sum representing a first margin for the dealer; and
using a computer online, the dealer making an offer on a dealer payment platform to users to sell the gift cards of the at least two different face amounts of the at least two advertisers, the offer stating that if a user purchases electronically from the dealer one of the gift cards, the user is then entitled to a particular digital product of the online publisher for free.

13. The method of claim 12, further comprising the user using a computer to pay the dealer online the face amount of the gift card that the user purchased, indication of the user's payment automatically generating from the dealer an electronic transmission of a code to the user, the code representing the gift card.

14. The method of claim 13, further comprising the user's payment also automatically generating an electronic transmission from the dealer to the online publisher indicating to the online publisher that the user is entitled to the product of the online publisher.

15. The method of claim 12, further comprising the dealer not identifying to the online publisher the at least two advertisers nor the online publisher to the at least two advertisers.

16. The method of claim 12, further comprising
the dealer using a computer online to electronically purchase a product from a second online publisher for a third fixed sum at a third absolute amount discount in real currency units, the third fixed sum less than the first discount by an amount representing a second margin for the dealer, the product offered online by the second online publisher.

17. The method of claim 16, further comprising
using a computer online, the dealer making an offer on a dealer payment platform to users at an electronic site of the second online publisher for sale of gift cards of at least two different face amounts of at least two advertisers, the offer stating that if a user purchases electronically from the dealer one of the gift cards of the at least two different face amounts of the at least two advertisers the user is then entitled to a particular product of the second online publisher.

18. The method of claim 17, further comprising the gift cards offered to users to obtain free products of the first online publishers and the gift cards offered to users to obtain free products of the second online publishers are the same gift cards.

19. The method of claim 12, further comprising the holder of the gift card need not ever redeem the gift card or ever transfer the gift card to a new holder in order to obtain the product of the online publisher.

20. The method of claim 12, further comprising the dealer electronically purchasing gift cards of at least two different face amounts from each of the at least two advertisers.
